(19) United States
(12) Patent Application Publication
(10) Pub. No.: US 2015/0149556 A1
(43) Pub. Date: May 28, 2015

(54) COMMUNICATION METHOD AND SYSTEM, AND COMPUTER STORAGE MEDIUM

(71) Applicant: TENCENT TECHNOLOGY (SHENZHEN) COMPANY LIMITED, Shenzhen, Guangdong (CN)

(72) Inventors: Yuewen Liu, Shenzhen (CN); Fan Yang, Shenzhen (CN); Chuan Chen, Shenzhen (CN); Minghang Gao, Shenzhen (CN); Weihua Chen, Shenzhen (CN)

(73) Assignee: TENCENT TECHNOLOGY (SHENZHEN) COMPANY LIMITED, Shenzhen, Guangdong (CN)

(21) Appl. No.: 14/406,937

(22) PCT Filed: Jun. 28, 2013
(86) PCT No.: PCT/CN2013/078400

§ 371 Date: Dec. 10, 2014

(30) Foreign Application Priority Data
Jul. 20, 2012 (CN) 201210252336.8

(51) Int. Cl. H04L 29/08

(52) U.S. Cl. CPC H04L 67/10
USPC 709/205

(57) ABSTRACT

It is described a communication method and system, and a computer storage medium. The method includes that: a communication account is allocated for a subscriber, personal information registered by the subscriber is received, an account of the subscriber on each communication platform is associated with the communication account; and a friend association is established for the subscriber according to the communication account and the personal information of the subscriber, and friend information of the subscriber is maintained. With the method, it is possible to facilitate friend information management by a subscriber, enhance efficiency in communication, and save communication resources.

The present application claims the priority of CN application No. 201210252336.8, titled “COMMUNICATION METHOD AND SYSTEM” filed on Jul. 20, 2012, the disclosure of which is incorporated by reference herein in its entirety.

### TECHNICAL FIELD

The present disclosure relates to the field of internet application, and in particular to a communication method and system, and a non-transitory computer storage medium.

### BACKGROUND

Various communication platforms, such as mobile terminals, E-Mails, internet forums, instant messaging tools, social networking sites, blogs, micro-blogs, appear with development of internet. A subscriber may communicate in real time, share information, etc. with others using such communication platforms via a client device.

At present, each communication platform generally has an account system per se, and a subscriber has to spend a lot of energy maintaining accounts and friends on different communication platforms. For example, the subscriber has to log into multiple communication platforms to view activity information of friends on the multiple communication platforms, and release identical activity information at multiple communication platforms, leading to waste of energy. Otherwise if the activity information is not released at each of the multiple communication platforms, then some friends who are on a communication platform where the activity information is not released will not be able to see the activity information of the subscriber. A friend may have different nick names on different communication platforms, which makes it hard for the subscriber to identify or even communicate with the friend. Moreover, with a highly mobile and fast developing modern society, contact information of a subscriber changes fast. Contact information of a friend on a mobile terminal of a subscriber expires soon, an account of the friend on a communication platform may have been abandoned, too, making it hard for the subscriber to get into contact with the friend. In addition, it costs much for the subscriber when replacing his/her own contact information, as the subscriber has to notify friends one by one. Therefore, all these issues present themselves as big barriers to communication between a subscriber and a friend.

### SUMMARY

In view of this, embodiments of the present disclosure provide a communication method and system, and a computer storage medium, capable of facilitating friend information management by a subscriber, enhancing efficiency in communication, and saving communication resources.

A technical solution of an embodiment of the present disclosure is implemented as follows.

Embodiments of the present disclosure provide a communication system, including a recording module and an association link module, wherein

the recording module is configured to allocate a communication account for a subscriber, receive personal information registered by the subscriber, associate an account of the subscriber on each communication platform with the communication account; and

the association link module is configured to establish a friend association for the subscriber according to the communication account and the personal information of the subscriber, and maintain friend information of the subscriber.

Embodiments of the present disclosure further provide a communication method, including steps of:

allocating a communication account for a subscriber, receiving personal information registered by the subscriber, associating an account of the subscriber on each communication platform with the communication account; and

establishing a friend association for the subscriber according to the communication account and the personal information of the subscriber, and maintaining friend information of the subscriber.

Embodiments of the present disclosure further provide a non-transitory computer-readable storage medium, storing computer executable instructions for executing a communication method according to an embodiment of the disclosure.

With a communication method or a communication system or a non-transitory computer-readable storage medium provided by embodiments of the present disclosure, a communication account is allocated for a subscriber, personal information registered by the subscriber is received, an account of the subscriber on each communication platform is associated with the communication account; and a friend association is established for the subscriber according to the communication account and the personal information of the subscriber, and friend information of the subscriber is maintained. In such a way, a subscriber does not have to manually manage and maintain personal information of a friend on a communication platform, facilitating friend information management by the subscriber. In addition, it is now possible to manage accounts of a subscriber on different communication platforms, reducing the cost of communication between the subscriber and a friend, enhancing efficiency in communication, and saving communication resources.

### BRIEF DESCRIPTION OF THE DRAWINGS

FIG. 1 is a schematic diagram of a structure of a communication system according to an embodiment of the present disclosure;

FIG. 2 is a flowchart of a communication method implemented according to an embodiment of the present disclosure;

FIG. 3 is a schematic diagram of a display interface of a communication system when personal activity information is released according to an embodiment of the present disclosure; and

FIG. 4 is a schematic diagram of a display interface of a communication system in maintaining a status of a friend according to an embodiment of the present disclosure.

### DETAILED DESCRIPTION

In embodiments of the present disclosure, a communication account is allocated for a subscriber, personal information registered by the subscriber is received, an account of the subscriber on each communication platform is associated with the communication account; and a friend association is established for the subscriber according to the communication account and the personal information of the subscriber, and friend information of the subscriber is maintained.

The present disclosure is further elaborated below with reference to the drawings and embodiments.

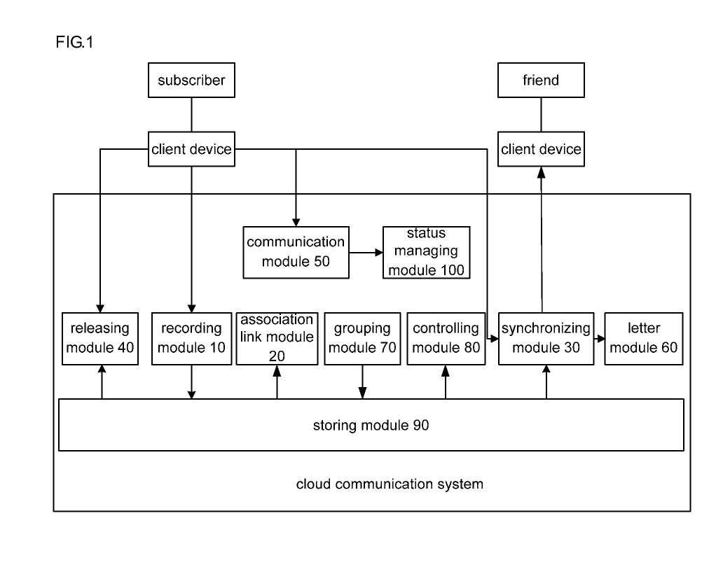

An embodiment of the present disclosure provides a communication system. FIG. 1 is a schematic diagram of a structure of a communication system according to an embodiment of the present disclosure. As shown in FIG. 1, the communication system includes a recording module 10 and an association link module 20.

The recording module 10 is configured to allocate a communication account for a subscriber, receive personal information registered by the subscriber, associate an account of the subscriber on each communication platform with the communication account.

The association link module 20 is configured to establish a friend association for the subscriber according to the communication account and the personal information of the subscriber, and maintain friend information of the subscriber.

In an embodiment, the system may further include:

a synchronizing module 30 configured to: when the personal information updated by the subscriber is received, synchronize, according to the friend information, the personal information updated by the subscriber to a communication account of a friend and a client device of the friend; and/or

a releasing module 40 configured to: when receiving personal activity information released by the subscriber, release the personal activity information simultaneously to multiple communication platforms.

In an embodiment, the system may further include:

a communication module 50 configured to: when receiving a message submitted by the subscriber, trigger a status managing module to inquire about a status of a friend on a communication platform whom the subscriber requests to contact, and send the message to an active account of the friend on a communication platform;

the status managing module 100 configured to: when being triggered by the communication module 50, inquire about a status of a friend on a communication platform whom the subscriber requests to contact; and/or

a letter module 60 configured to: acquire new friend information and new personal activity information of a friend of the subscriber, merge the identical new friend information or the identical new personal activity information on different communication platforms as one piece of information, sort the new friend information and the new personal activity information, generate a friend information bulletin, and provide the friend information bulletin to the subscriber.

In an embodiment, the system may further include:

a grouping module 70 configured to receive and save identical or different information accessing authorizations configured for different friend groups; and

a controlling module 80 configured to control, according to a configured information accessing authorization, a friend of the subscriber in viewing the personal information and personal activity information of the subscriber.

In an embodiment, the system may further include a storing module 90 configured to: save the personal information of the subscriber, an acquired address list and a correspondence between the personal information of the subscriber and the address list; and/or save the friend information of the subscriber; and/or save accessing authorization information.

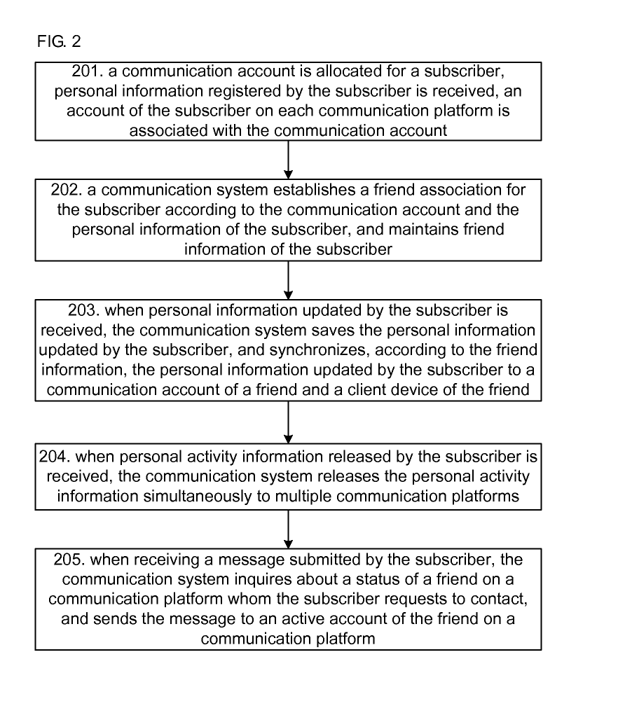

Based on the system, an embodiment of the present disclosure further provides a communication method. FIG. 2 is a flowchart of a communication method according to an embodiment of the present disclosure. As shown in FIG. 2, the method includes steps as follows.

In step 201, a communication account is allocated for a subscriber, personal information registered by the subscriber is received, an account of the subscriber on each communication platform is associated with the communication account.

In an embodiment, when a communication system receives a request of the subscriber for registration, a recording module of the communication system allocates a unique communication account for the subscriber. Based on the communication account, the subscriber may register his/her personal information via a client device. The personal information may include: a personal profile of the subscriber, contact information of the subscriber, personal information of a friend, an account and a password (corresponding to the account) of the subscriber on a communication platform. The recording module of the communication system may receive the personal information registered by the subscriber, and may further acquire automatically an address list of the subscriber from the client device of the subscriber. A storing module saves the personal information of the subscriber, the acquired address list and a correspondence between the personal information of the subscriber and the address list.

The recording module of the communication system may associate with a communication platform via a login Application Programming Interface (API) of the communication platform. For example, when the subscriber logs into the communication system, the communication system automatically call a login API of the communication platform by means of an account and a password preset on the communication platform, to acquire an encrypted Uniform Resource Locator (URL) character string of a personal homepage on the communication platform. The encrypted URL character string is taken as an associated link, such as “account@communication platform”. In such a way, the subscriber may directly jump to the personal homepage on the communication platform via the encrypted URL character string simply by clicking on the associated link “account@communication platform”.

In step 202, the communication system establishes a friend association for the subscriber according to the communication account and the personal information of the subscriber, and maintains friend information of the subscriber.

In an embodiment, the association link module of the communication system automatically acquires friend information of the subscriber on each communication platform according to the account and the password on the communication platform provided by the subscriber, wherein the friend information includes one or more of the following: an account of the friend, a nick name of the friend, direction information of the friend association, a remark, grouping information. The friend information of the subscriber acquired by the association link module is saved in the storing module of the communication system.

The association link module of the communication system may look, according to the personal information of the subscriber and the friend information of the subscriber, for a communication account that matches the communication account of the subscriber, and recommend to the subscriber a matching communication account as a friend of the subscriber. The subscriber may also search the association link module of the communication system for other communication accounts. The association link module may display, according to the address list of the subscriber and the friend information of the subscriber on a communication platform, a search result preferably starting with a communication account with a high correlation. The subscriber may send a friend invitation to a recommended communication account or a communication account found via search. When a response accepting the friend invitation returned by the invited communication account is received, it means that the invitation is accepted, and the subscriber may then establish the friend association with the invited communication account. The two subscribers with an established friend association may select to share personal information, such as a phone number, a mail address, an account on a communication platform and the like.

A grouping module of the communication system provides automatic grouping for the subscriber or prompts the subscriber to group friends, according to the acquired address list and grouping information in the friend information. The subscriber may perform grouping adjustment on a friend via the grouping module of the communication system. The communication system receives identical or different information accessing authorizations configured by the subscriber for different friend groups, such that accessing authorizations may be controlled accurately to the extent of a friend group, or to a single friend. A controlling module of the communication system controls, based on a configured information accessing authorization, a friend of the subscriber in viewing the personal information and personal activity information of the subscriber. The storing module saves information on an accessing authorization.

In step 203, when personal information updated by the subscriber is received, the communication system saves the personal information updated by the subscriber, and synchronizes, according to the friend information, the personal information updated by the subscriber to a communication account of a friend and a client device of the friend.

In an embodiment, when receiving the personal information updated by the subscriber, such as an updated cell phone number, an updated E-Mail, a new account registered on a communication platform, the synchronizing module of the communication system first saves the personal information updated by the subscriber in the storing module of the communication system, then automatically synchronizes the personal information updated by the subscriber to the communication account of the friend according to personal information of a friend and information accessing authorization allocated for the friend.

In the communication system, when receiving the personal information updated by the subscriber, the communication account of the friend updates personal information of the subscriber previously saved in a storage unit with the updated personal information of the subscriber. Moreover, if the new personal information includes new contacts information, such as a new cell phone number, then the synchronizing module of the communication system takes initiative to issue, to the client device of the friend, contacts information contained in the updated personal information of the subscriber. After receiving the new contacts information of the subscriber, a downloading module of the client device of the friend sends the new contacts information to an address list of the client device. The received new contacts information is saved in the address list, so as to update contacts information of the subscriber in the client device of the friend in time. In such a way, when there is a change in the contact information of the subscriber, all friends are notified of the change fast and automatically via the synchronizing module of the communication system, without the need of being notified one by one.

In step 204, when personal activity information released by the subscriber is received, the communication system releases the personal activity information simultaneously to multiple communication platforms.

In an embodiment, the subscriber may release, via the communication system, the personal activity information to multiple communication platforms simultaneously. When the personal activity information is released, the releasing module of the communication system receives the personal activity information uploaded by the subscriber via a client device, and one or more accounts on one or more communication platforms selected by the subscriber via the client device. The releasing module of the communication system releases the received personal activity information simultaneously to the one or more communication platforms corresponding to the selected one or more accounts. The personal activity information may include various information, such as text, a picture, an audio, or a video.

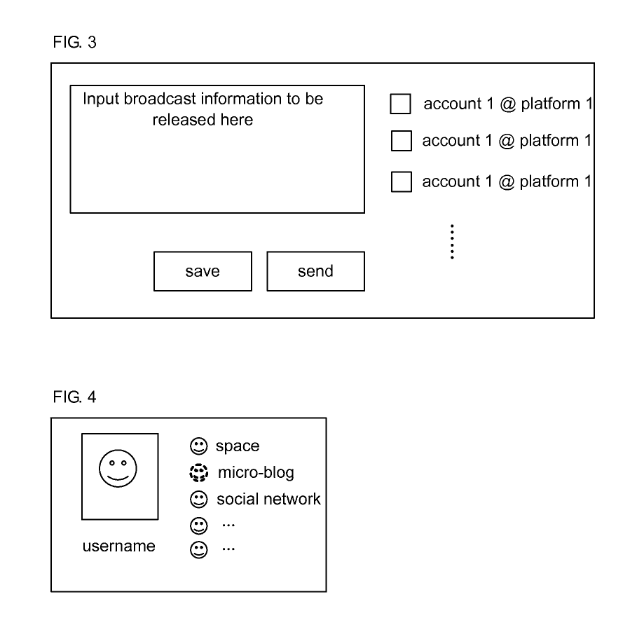

For example, as shown in FIG. 3, the releasing module of the communication system displays an interface in FIG. 3 before the subscriber via a client device. The subscriber may input specific content of personal activity information to be released, and may select an account to which the personal activity information is to be released by checking a check box on the right. Thus, the releasing module of the communication system sends the input personal activity information to any communication platform corresponding to each selected account once for all, without the need for the subscriber to send the personal activity information of identical content to multiple communication platforms one by one, implementing simpler and faster release of personal activity information, intelligently assisting interaction and communication between the subscriber and a friend, reducing cost of communication between a subscriber and a friend.

In step 205, when receiving a message submitted by the subscriber, the communication system inquires about a status of a friend on a communication platform whom the subscriber requests to contact, and sends the message to an active account of the friend on a communication platform.

In an embodiment, as the communication system associates respectively with different communication platforms of the subscriber, when there is a change in the status of a friend on a communication platform, the communication platform may report information on the status of the friend to the status managing module of the communication system in time. When the subscriber inquires about the status of the friend, the status managing module may acquire information on the status of the friend from the communication platform where the friend locates, and may show the subscriber (if the subscriber has the authorization to view the status of the friend) information on the status of the friend on the communication platform by using an interface shown in FIG. 4, for example. The status information may comprise an on/off-line status, a recent active time, and the like. The on/off-line status of the friend may be shown by a light/dark icon.

When the subscriber needs to contact a friend, the subscriber sends a request to the communication system via a client device, the request including message content and a friend whom the subscriber requests to contact. After receiving the request, the communication module of the communication system inquires, via the status managing module, about the status of the friend (whom the subscriber requests to contact) on a communication platform where the friend locates. When the friend is on line on the communication platform, the friend is deemed to be active on the communication platform, then the communication module sends, via the account of the subscriber on the communication platform, the message to the communication platform on which the friend is currently active. The friend will watch the message via a client device of the communication platform. When the friend is active on multiple communication platforms, the message content is sent to a communication platform with a highest priority. The priority of each communication platform is preset by the subscriber. When the friend is not on line on any communication platforms, the friend may be notified of the message content via a short message and the like. The message content may be information such as text, a picture, an audio, a video and the like.

Moreover, the letter module in the communication system may acquire, from the synchronizing module, new friend information and new personal activity information of a friend of the subscriber, and may perform integration on the new friend information and the new personal activity information by merging identical information on different communication platforms as one piece of information. The letter module sorts the new friend information and the new personal activity information according to time or in some ways, and finally generates a friend information bulletin, and provides the friend information bulletin to the subscriber, thereby enabling automatic integration of information updated by a friend.

### Embodiment

As the communication system is associated with different communication platforms used by the subscriber, after logging into the communication system, the subscriber may directly jump to a communication platform via an account pre-configured on the communication platform simply by clicking on an associated link for example “account@communication platform”, and may also view an information bulletin of a communication platform directly in the communication system, without the need to log into different communication platforms one by one, implementing simpler and faster login and view on multiple communication platforms.

In an embodiment of the present disclosure, a communication platform may be an instant communication tool, a blog, a micro-blog, a social networking site and the like provided by a service provider.

When implemented in form of a software functional module and sold or used as an independent product, an integrated module of an embodiment of the present disclosure may also be stored in a non-transitory computer-readable storage medium. Based on such an understanding, the essential part or a part contributing to prior art of the technical solution of an embodiment of the present disclosure may appear in form of a software product, which software product is stored in storage media, and includes a number of instructions for allowing a computer equipment (such as a personal computer, a server, a network equipment, or the like) to execute all or part of the methods in various embodiments of the present disclosure. The storage media include various media that can store program codes such as a U disk, a mobile hard disk, a Read-Only Memory (ROM), a Random Access Memory (RAM), a magnetic disk, a CD, and the like. Thus, an embodiment of the present disclosure is not limited to any specific combination of hardware and software.

Accordingly, an embodiment of the present disclosure further provides a non-transitory computer-readable storage medium storing a computer program for executing a communication method according to an embodiment of the present disclosure.

What described are merely embodiments of the present disclosure and are not intended to limit the scope of the present disclosure. Any modification, equivalent replacement, improvement, and the like made within the spirit/principle of the disclosure are included in the scope of the disclosure.

1. (canceled)

2. A communication system, comprising:
a recording module, configured to allocate a communication account for a subscriber, receive personal information registered by the subscriber, associate an account of the subscriber on a communication platform with the communication account; and
an association link module, configured to establish a friend association for the subscriber according to the communication account and the personal information of the subscriber, and maintain friend information of the subscriber,
the system further comprising:
a synchronizing module configured to: when the personal information updated by the subscriber is received, synchronize, according to the friend information, the personal information updated by the subscriber to a communication account of a friend and a client device of the friend; and/or
a releasing module configured to: when receiving personal activity information released by the subscriber, release the personal activity information simultaneously to multiple communication platforms where the subscriber locates.

3. A communication system, comprising:
a recording module, configured to allocate a communication account for a subscriber, receive personal information registered by the subscriber, associate an account of the subscriber on a communication platform with the communication account; and
an association link module, configured to establish a friend association for the subscriber according to the communication account and the personal information of the subscriber, and maintain friend information of the subscriber,
the system further comprising: a communication module and a status managing module, and/or a letter module,
wherein the communication module is configured to: when receiving a message submitted by the subscriber, trigger the status managing module to inquire about a status of a friend on a communication platform whom the subscriber requests to contact, and send the message to an active account of the friend on the communication platform,
wherein the status managing module is configured to: when being triggered by the communication module, inquire about the status of the friend on the communication platform whom the subscriber requests to contact,
wherein the letter module is configured to: acquire new friend information and new personal activity information of the friend of the subscriber, merge identical new friend information or identical new personal activity information of the friend on different communication platforms, sort the new friend information and the new personal activity information of the friend, generate a friend information bulletin comprising the new friend information and the new personal activity information of the friend, and provide the friend information bulletin to the subscriber.

4. A communication system, comprising:
a recording module, configured to allocate a communication account for a subscriber, receive personal information registered by the subscriber, associate an account of the subscriber on a communication platform with the communication account;
an association link module, configured to establish a friend association for the subscriber according to the communication account and the personal information of the subscriber, and maintain friend information of the subscriber;
a grouping module, configured to receive and save identical or different information accessing authorizations configured for different friend groups; and
a controlling module, configured to control, according to a configured information accessing authorization, a friend of the subscriber in viewing the personal information and personal activity information of the subscriber.

5. The system according to claim 2, further comprising:
a storing module, configured to: save the personal information of the subscriber, an acquired address list and a correspondence between the personal information of the subscriber and the address list; and/or save the friend information of the subscriber; and/or save accessing authorization information.

6. A communication method, comprising:
allocating a communication account for a subscriber, receiving personal information registered by the subscriber, associating an account of the subscriber on a communication platform with the communication account; and
establishing a friend association for the subscriber according to the communication account and the personal information of the subscriber, and maintaining friend information of the subscriber,
the method further comprising:
when a message submitted by the subscriber is received, inquiring about a status of a friend on a communication platform whom the subscriber requests to contact, and sending the message to an active account of the friend on the communication platform; and/or
acquiring new friend information and new personal activity information of the friend of the subscriber, merging identical new friend information or identical new personal activity information of the friend on different communication platforms, sorting the new friend information and the new personal activity information of the friend, generating a friend information bulletin comprising the new friend information and the new personal activity information of the friend, and providing the friend information bulletin to the subscriber.

7. A communication method, comprising:
allocating a communication account for a subscriber, receiving personal information registered by the subscriber, associating an account of the subscriber on a communication platform with the communication account; and
establishing a friend association for the subscriber according to the communication account and the personal information of the subscriber, and maintaining friend information of the subscriber,
the method further comprising:
when personal information updated by the subscriber is received, saving the personal information updated by the subscriber, and synchronizing, according to the friend information, the personal information updated by the subscriber to a communication account of a friend and a client device of the friend; and/or
when personal activity information released by the subscriber is received, releasing the personal activity information simultaneously to multiple communication platforms where the subscriber locates.

8. The method according to claim 7, further comprising:
when a message submitted by the subscriber is received, inquiring about a status of a friend on a communication platform whom the subscriber requests to contact, and sending the message to an active account of the friend on the communication platform; and/or
acquiring new friend information and new personal activity information of the friend of the subscriber, merging identical new friend information or identical new personal activity information of the friend on different communication platforms, sorting the new friend information and the new personal activity information of the friend, generating a friend information bulletin comprising the new friend information and the new personal activity information of the friend, and providing the friend information bulletin to the subscriber.

9. A communication method, comprising:
allocating a communication account for a subscriber, receiving personal information registered by the subscriber, associating an account of the subscriber on a communication platform with the communication account; and
establishing a friend association for the subscriber according to the communication account and the personal information of the subscriber, and maintaining friend information of the subscriber,
wherein the step of allocating a communication account for a subscriber, receiving personal information registered by the subscriber, associating an account of the subscriber on each communication platform with the communication account, comprises:
when a request of the subscriber for registration is received, allocating the communication account which is unique for the subscriber, receiving and saving the personal information registered by the subscriber; and
calling a login Application Programming Interface (API) of a communication platform by using an account and a password preset on the communication platform, to acquire an encrypted Uniform Resource Locator (URL) character string of a personal homepage on the communication platform, and taking the encrypted URL character string as an associated link.

10. The method according to claim 7, wherein the personal information comprises one or more of: personal profile of the subscriber, contact information of the subscriber, personal information of a friend, an account and a password of the subscriber on a communication platform.

11. A communication method, comprising:
allocating a communication account for a subscriber, receiving personal information registered by the subscriber, associating an account of the subscriber on a communication platform with the communication account; and
establishing a friend association for the subscriber according to the communication account and the personal information of the subscriber, and maintaining friend information of the subscriber,
wherein the step of establishing a friend association for the subscriber according to the communication account and the personal information of the subscriber, comprises:
acquiring the friend information of the subscriber on each communication platform according to the account and a password on the communication platform provided by the subscriber, and saving the acquired friend information;
looking, according to the personal information of the subscriber and the friend information of the subscriber, for a communication account that matches the communication account of the subscriber, recommending a matching communication account to the subscriber;
or searching communication accounts, and displaying according to an address list of the subscriber and the friend information of the subscriber on the communication platform, a search result starting with the communication account with a high correlation; and
sending a friend invitation to a recommended communication account or a communication account found via search, and when a response accepting the friend invitation returned by the invited communication account is received, establishing the friend association between the subscriber and the invited communication account.

12. A communication method, comprising:
allocating a communication account for a subscriber, receiving personal information registered by the subscriber, associating an account of the subscriber on a communication platform with the communication account; and
establishing a friend association for the subscriber according to the communication account and the personal information of the subscriber, and maintaining friend information of the subscriber,
wherein the step of maintaining friend information of the subscriber comprises:
grouping friends or prompting to group friends, according to an acquired address list and grouping information in the friend information; and
receiving and saving identical or different information accessing authorizations configured for different friend groups; and controlling, according to a configured information accessing authorization, a friend of the subscriber in viewing the personal information and personal activity information of the subscriber.

13. The method according to claim 7, wherein the step of synchronizing, according to the friend information, the personal information updated by the subscriber to a communication account of a friend and a client device of the friend, comprises:
when the personal information updated by the subscriber is received, synchronizing, according to the personal information of the friend and information accessing authorization allocated for the friend, the personal information updated by the subscriber to the communication account of the friend; when receiving the updated personal information of the subscriber, updating, by the communication account of the friend, personal information of the subscriber previously saved in a storage unit with the updated personal information of the subscriber; and
when the updated personal information comprises new contacts information, sending the new contacts information to the client device of the friend, such that after receiving the new contacts information, the client device saves the new contacts information in an address list of the friend, so as to update contacts information of the subscriber in the client device of the friend.

14. The method according to claim 7, wherein the step of releasing the personal activity information simultaneously to multiple communication platforms, comprises:
receiving the personal activity information uploaded by the subscriber via a client device and one or more accounts on one or more communication platforms selected by the subscriber via the client device; and
releasing the received personal activity information simultaneously to the one or more communication platforms corresponding to the selected one or more accounts.

15. A non-transitory computer-readable storage medium, storing computer executable instructions for executing the communication method according to claim 6.

16. The system according to claim 3, further comprising:
a storing module, configured to: save the personal information of the subscriber, an acquired address list and a correspondence between the personal information of the subscriber and the address list; and/or save the friend information of the subscriber; and/or save accessing authorization information.

17. The system according to claim 4, further comprising:
a storing module, configured to: save the personal information of the subscriber, an acquired address list and a correspondence between the personal information of the subscriber and the address list; and/or save the friend information of the subscriber; and/or save accessing authorization information.

18. The method according to claim 9, wherein the personal information comprises one or more of: personal profile of the subscriber, contact information of the subscriber, personal information of a friend, an account and a password of the subscriber on a communication platform.

19. A non-transitory computer-readable storage medium, storing computer executable instructions for executing the communication method according to claim 7.

20. A non-transitory computer-readable storage medium, storing computer executable instructions for executing the communication method according to claim 9.

21. A non-transitory computer-readable storage medium, storing computer executable instructions for executing the communication method according to claim 11.

22. A non-transitory computer-readable storage medium, storing computer executable instructions for executing the communication method according to claim 12.
